(19) United States
(12) Patent Application Publication
(10) Pub. No.: US 2012/0006482 A1
(43) Pub. Date: Jan. 12, 2012

(54) METHOD FOR IMPROVING RUBBER BONDING PROPERTY BETWEEN RUBBER AND EPOXY-COMPOSITE

(75) Inventors: Byeong-Yeol PARK, Daejeon (KR); Moon-Sam RYOO, Deajeon (KR); Chang-Kee KIM, Deajeon (KR)

(73) Assignee: AGENCY FOR DEFENSE DEVELOPMENT, DAEJEON (KR)

(21) Appl. No.: 13/112,505

(22) Filed: May 20, 2011

(30) Foreign Application Priority Data
Jul. 7, 2010 (KR) 10-2010-65551

(51) Int. Cl. B32B 37/26

(52) U.S. Cl. 156/308.2

(57) ABSTRACT

Disclosed is a method for improving the bonding property between a rubber material and an epoxy resin-based composite, particularly which can improve bonding of the rubber material to the epoxy resin-based composite without using an interfacial adhesive layer, by using, as the rubber material to be adhered to the epoxy resin-based composite, a mixture of an epoxy resin and rubber, wherein the method comprises laminating a layer of the composite and a layer of the rubber-epoxy resin mixture, and co-curing the composite layer and the rubber-epoxy resin mixture layer at the same time.

### FIELD OF THE INVENTION

The present invention relates to a method for improving the bonding property between rubber and epoxy composite, particularly to a method which can improve bonding of rubber to epoxy composite without using an interfacial adhesive layer, by using, as a rubber material to be adhered to the epoxy composite, a mixture of an epoxy resin and rubber (hereinafter, referred as ‘rubber-epoxy resin mixture’), laminating the composite and a layer of the rubber-epoxy resin mixture, and performing simultaneous curing of the composite and the rubber-epoxy resin mixture.

### BACKGROUND OF THE INVENTION

A propellant of a rocket missile is contained in a pressure-resistant container made of a composite material. Upon ignition of the propellant, the inside of the pressure-resistant container made a composite material becomes under the conditions of high temperature and high pressure. A rubber layer having insulating and heat-resistant properties is placed inside of the composite material container so as to prevent the pressure-resistant case from the heat with very high temperature generated during combustion of the propellant. Moreover, the exterior of such pressure-resistant composite material case is formed by a fiber/resin layer which tolerates the high internal pressure. The pressure-resistant composite material case is generally fabricated by primarily layering unvulcanized rubber onto the surface of a mandrel having a desired shape and then covering the rubber with an adhesive agent. Next, onto the resulted surface, fibers coated with resin are placed via filament winding technique. The resulted product is subjected to an oven wherein the unvulcanized rubber, the adhesive agent and fiber coated with resin are co-cured and thus bonded together. Ethylene propylene diene monomer (EPDM) rubber is commonly used as the rubber component, owing to its desirable heat insulation property and heat resistance as well as its low specific gravity. As for the resins used for the resin component, epoxy-type resins, for example diglycidyl ethers of bisphenol A or bisphenol F with an aromatic amine curing agent are generally used. Carbon fibers having high mechanical strength are used for the fiber component.

Related with the adhesive agent, U.S. Pat. No. 6,495,259 discloses a mixture comprising at least one rubber component, acrylate component and a hydrocarbon solvent for facilitating mixing. However, such use of a solvent or a mixed solvent demands special techniques in handling and to meet various environmental regulations.

As an alternative, commercially available adhesives such as Chemlok 234 and Chemlok 236 from Lord Corporation may be considered for use. However, these commercialized adhesives still contain a considerable amount of solvents, requiring special caution in handling. Further problems are caused by using commercialized adhesives, since these adhesives contain various species of active ingredients for bonding a number of different types of substances together. For example, since commercialized adhesives are formulated for bonding metal, ceramic, glass, plastic surfaces and the like, they may contain various active ingredients suitable for bonding every different type of surfaces. When using such adhesive containing multiple active ingredients, each of the active ingredients may affect the bonding properties in many different ways, thus possibly resulting in adverse effect on the bonding strength as a whole. In other words, some active ingredients which do not directly participate in adhesion could lower the bonding strength, as compared to when using an adhesive which only contains selective active ingredients suitable for the bonding of a certain targeted surfaces.

### OBJECT OF THE INVENTION

With a purpose to solve the problems existed in prior arts, the present invention is to provide a method for improving the bonding property when bonding a rubber material to a composite comprising an epoxy resin binder.

### BRIEF SUMMARY OF THE INVENTION

The method for improving the bonding property between a rubber material and an epoxy resin-based composite according to the present invention is characterized by laminating a layer of a rubber-epoxy resin mixture as the rubber material and an epoxy resin-based composite layer and co-curing them, wherein the rubber-epoxy resin mixture comprises 3.0-5.0 wt % of an epoxy resin and 97.0-95.0 wt % of rubber, based on the total weight of the rubber-epoxy resin mixture.

The rubber used herein is not specifically limited, however, preferably used is a synthetic rubber, particularly EPDM rubber, ethylene-propylene copolymer rubber, nitrobutadiene rubber (NBR) and the like.

The epoxy resin to be mixed with the rubber material used herein is not specifically limited, however, preferred is a latent epoxy resin which undergoes no reactions at room temperature and can be cured at an elevated temperature near a vulcanizing temperature range of the unvulcanized rubber material, for example, preferably an epoxy resin with an aromatic amine curing agent, bisphenol A epoxy resin and the like.

The amount of the epoxy resin being mixed to the rubber is preferably 3-5 wt %. When the amount is less than 3 wt %, the bonding strength is lowered. On the contrary, when it is more than 5 wt %, the mechanical properties of the original rubber can be deteriorated by the epoxy resin which has relatively higher hardness, although the bonding strength between the rubber material layer and the epoxy resin-based composite layer can be increased.

The rubber-epoxy resin mixture may further comprise one or more conventional additives as desired, for example carbon fiber, silica powder, aramid fiber, filler and the like.

The rubber-epoxy resin mixture is preferably in uncured state before subjecting it to bonding process. Such rubber mixture in uncured state has relatively longer pot life.

According to the present invention, it is possible to improve the bonding strength between a rubber material and an epoxy resin-based composite material, even in the absence of an adhesive, by using rubber-epoxy resin mixture as the rubber material

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a cross-sectional view of a conventional specimen wherein a rubber layer 12 is bonded to a composite layer 14 by way of an adhesive layer 16;

FIG. 2 is a cross-sectional view of an embodiment according to the present invention wherein a rubber-epoxy resin mixture layer 12′ (hereinafter, referred as ‘rubber mixture layer’) is bonded to an epoxy resin-based composite layer 14 (hereinafter, referred as ‘composite layer’) without an adhesive layer; and

FIG. 3 is a rocket motor including a composite material combustion pipe 10 bonded according to the method of the present invention.

### DETAILED DESCRIPTION OF THE INVENTION

Hereinafter, the method for improving the bonding property between a rubber material and an epoxy resin-based composite material according to the present invention is further illustrated by way of an embodiment of the present invention in which a combustion pipe made of composite material (hereinafter, referred as ‘composite material combustion pipe’) for a rocket motor is described, in reference with the drawings attached to this specification

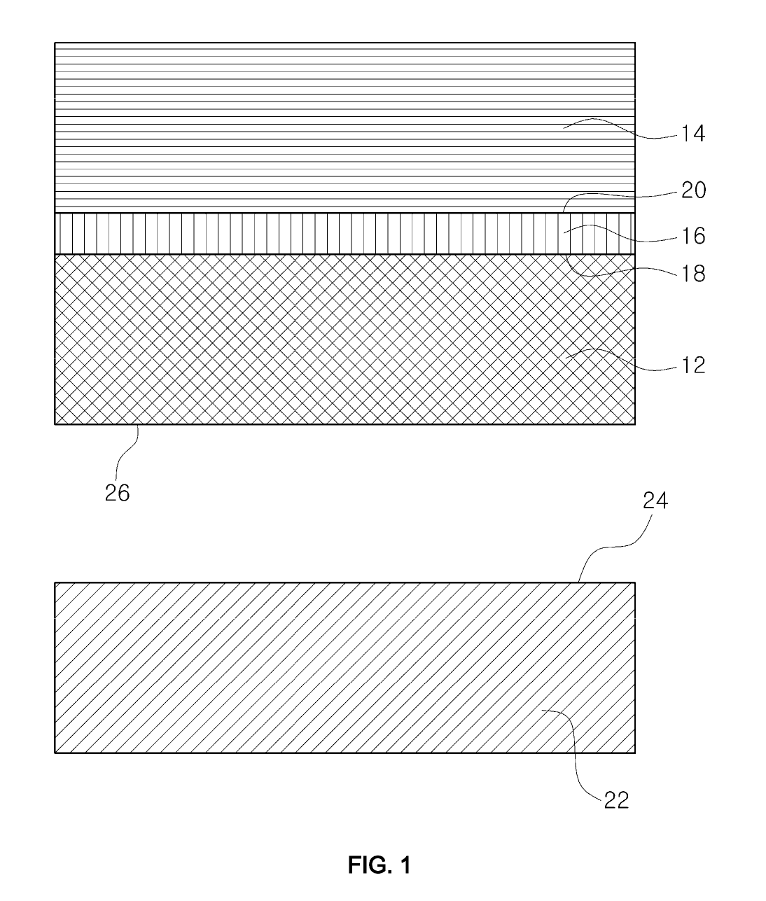

FIG. 1 is a cross-sectional view of a conventional specimen wherein a rubber layer 12 is bonded to a composite layer 14 by way of an adhesive layer 16.

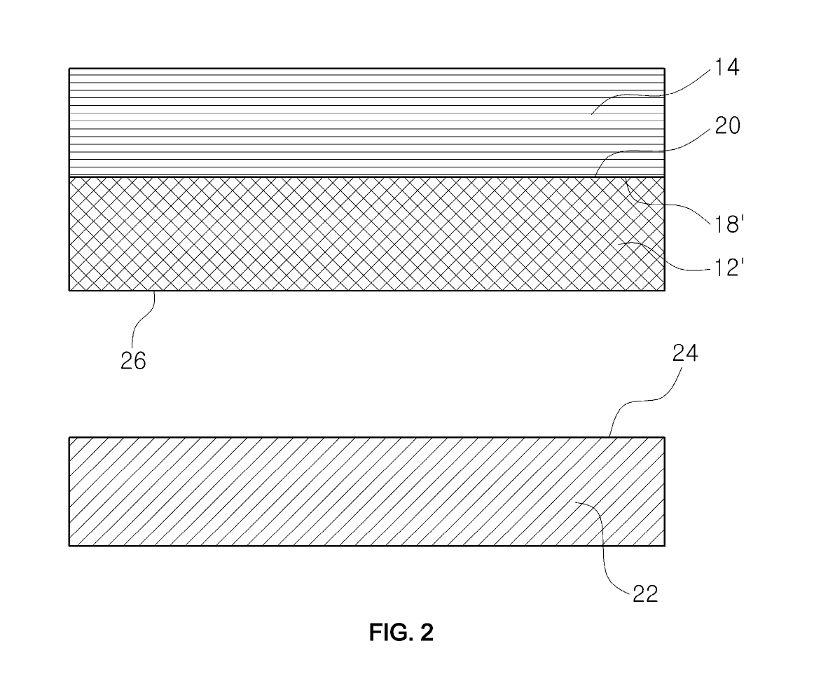

FIG. 2 is a cross-sectional view of an embodiment according to the present invention wherein a rubber mixture layer 12′ is bonded to a composite layer 14 without an adhesive layer.

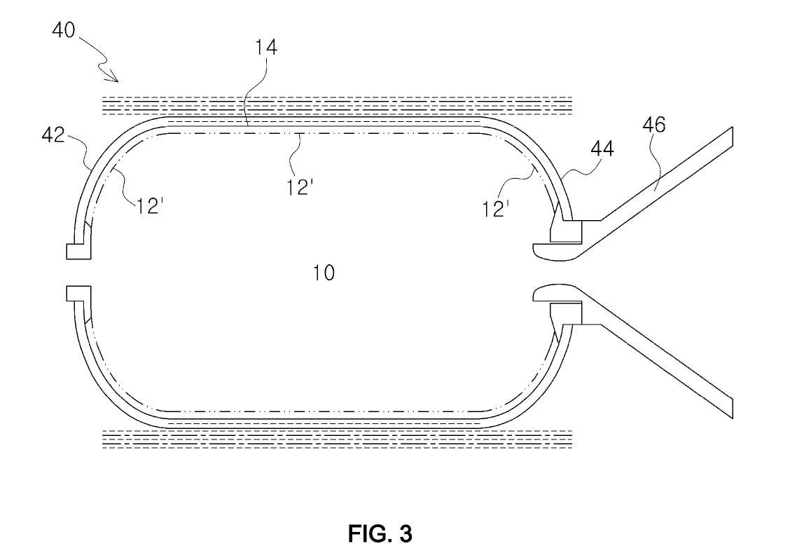

FIG. 3 is a rocket motor comprising a composite material combustion pipe 10 to which the rubber mixture layer and the composite layer are bonded each other according to the method of the present invention, wherein the composite material combustion pipe 10 is an assembly formed by bonding a composite material layer 14 comprising an epoxy resin as a binder onto the rubber mixture layer 12′ without using an interfacial adhesive.

The combustion pipe 10 is not specifically limited in terms of shape, however it can have hollow inside, and for example a solid-propellant rocket combustion pipe generally in a cylindrical shape which forms an important portion of a solid-propellant rocket motor 40.

The combustion pipe 10 is comprised of a front dome 42, a rear dome 44 and a nozzle 46.

The rubber mixture layer 12′ is placed on the surface 24 of a mold 22 for forming the size and an inner shape of the rubber mixture layer 12′.

The mold 22 is usually made of aluminum or other metals and formed as dividable so as to facilitate removal of the mold. The mold can shrink and thus the surface 24 of the mold is detached and removed from the surface of the rubber mixture layer 12′.

The composite material layer 14 is provided primarily in the form of fiber made of an epoxy resin reinforced with fibers such as carbon, graphite, boron, glass and aramid fibers or in the form of tow, fabric, cloth, mesh or strand.

Further, the composite material layer 14 may be provided in the form of a prepreg made of an epoxy resin impregnated fiber. The prepreg may be wound or covered around the surface 18′ of the rubber mixture layer 12′.

The rubber mixture layer 12′ and the composite material layer 14 in an assembled structure are preferably in uncured state before being placed into an autoclave or oven. Alternatively, the rubber mixture layer 12′ and the composite material layer 14 in an assembled structure are preferably, not mandatorily, in partially cured state, not completely cured state. It is to carry out co-curing of the layers of the assembly under high temperature condition in an oven, autoclave or other heating devices so as to form a durably bonded assembly in the form of one body. The bonding occurred on the surfaces between the layers can be maximized by co-curing at an elevated temperature in an oven or autoclave, i.e. via epoxy chemical reactions between the latent epoxy resin in the rubber mixture and the epoxy resin-based composite material, providing a hard surface-to-a soft surface interface.

The one-step bonding (co-curing) process according to the present invention is more efficient, which can avoid an increase in manufacturing costs associated with increased labor and device operation, or problems in oven or autoclave availability due to conflicts in production schedule.

The assembled structure in the shape of a combustion pipe in which the rubber mixture layer 12′ and the composite material layer 14 are assembled together is placed in an oven, autoclave or other heating devices for curing. On completion of curing, the mold 22 is removed from the structure through its hollow center, resulting in an isolated composite material combustion pipe 10. The resulted composite material combustion pipe 10 can be used in fabrication of a rocket motor.

The method according to the present invention has been so far described by an embodiment of a composite material combustion pipe for a rocket motor, in which a composite material layer 14 having an uncured epoxy resin as a binder is layered on a rubber mixture layer 12′ that contains uncured latent epoxy resin and bonded together by co-curing in the absence of an adhesive layer. However, it should be understood that the method according to the present invention is not limited to the given embodiment and can have many applications which include bonding of at least two materials, such as for example manufacturing of other parts of a rocket motor or various articles or parts.

In other words, although the method according to the present invention may be particularly suitable for the fabrication of a composite material combustion pipe for a rocket motor, it still can be preferably applied to a preparation of an article or a product which comprises bonding of a rubber material and a composite material having an epoxy resin binder.

### EFFECT OF THE INVENTION

According the method of the present invention, it is possible to obtain excellent bonding between a rubber material and an epoxy resin-based composite in the absence of a separate adhesive layer, by epoxy chemical bonding between the latent epoxy resin incorporated in the rubber material and the epoxy resin-based composite which makes possible to co-cure the rubber material and the epoxy resin-based composite at an elevated temperature. This method finds suitable applications in fabrication of a combustion pipe made of a composite material used in a rocket motor by making it possible to achieve bonding between an internal rubber mixture layer and the composite layer without an adhesive agent.

### EMBODIMENT OF THE INVENTION

### Example

As shown in FIG. 1, a specimen 1 according to a conventional method was prepared by bonding a 2 mm-thick rubber (EPDM) layer to a 5 mm-thick epoxy resin-based composite (a prepreg that is aramid fiber impregnated with an epoxy resin) using an adhesive layer. As shown in FIG. 2, a specimen 2 according to an embodiment of the present invention was prepared, in which a 2 mm-thick rubber (EPDM)/epoxy resin mixture (95:5 of weight ratio) layer and a 5 mm-thick epoxy resin-based composite (a prepreg that is aramid fiber impregnated with an epoxy resin) were directly bonded together in the absence of an adhesive agent.

A peel test for comparing the adhesiveness of the specimen 1 and the specimen 2 was carried out. The results were given in the following Table 1.

TABLE 1

| | Specimen 1 | Specimen 2 |
|---|---|---|
| Peel test (kg/cm)* | 1.5 | 3 |

*The peel test was carried out following the standard method for determining the peel resistance of an adhesive according to ASTM D1876, in which the rubber layer (specimen 1) or the rubber mixture layer (specimen 2) was peeled from the epoxy resin-based composite layer at an angle of 90 degrees kept throughout the test.

From the results of the peel test given in the above Table 1, it is found that the specimen 2 according to an embodiment of the present invention exhibits superior adhesiveness as compared to the specimen 1 of prior arts, which has an interfacial adhesive layer.

Numerals in FIGS.

10: combustion pipe made of composite material
12: rubber layer
12′: rubber mixture layer
14: composite layer
16: adhesive layer
18: surface of the rubber layer
18′: surface of the rubber mixture layer
20: inner surface of the composite layer
22: mold
24: mold surface
40: rocket motor
42: front dome of the combustion pipe
44: rear dome of the combustion pipe
46: nozzle

What is claimed is:

1. A method for improving the bonding property between a rubber material and an epoxy resin-based composite, which comprises laminating a layer of a rubber-epoxy resin mixture as the rubber material and a layer of an epoxy resin-based composite and co-curing of the laminated layers, wherein the rubber-epoxy resin mixture comprises 3.0-5.0 wt % of an epoxy resin and 95.0-97.0 wt % of rubber, based on the total weight of the rubber-epoxy resin mixture.

2. The method according to claim 1, wherein the rubber is ethylene propylene diene monomer (EPDM) rubber or ethylene-propylene copolymer rubber.

3. The method according to claim 1, wherein the epoxy resin is an epoxy resin with an aromatic amine curing agent.

4. The method according to claim 3, wherein the composite comprises carbon fiber.
